(19) United States
(12) Patent Application Publication
(10) Pub. No.: US 2012/0153748 A1
(43) Pub. Date: Jun. 21, 2012

(54) VIBRATION GENERATOR

(76) Inventor: Tomokuni Wauke, Miyagi-ken (JP)

(21) Appl. No.: 13/327,405

(22) Filed: Dec. 15, 2011

(30) Foreign Application Priority Data
Dec. 17, 2010 (JP) 2010-281552

(51) Int. Cl. H02K 33/00

(52) U.S. Cl. 310/25

(57) ABSTRACT

An elastic support member that supports a vibrator includes a first elastic deformation portion and a second elastic deformation portion that are integrally formed from a leaf spring material. When the first elastic deformation portion bending-deforms in an X direction, the vibrator vibrates in the X direction. When the second elastic deformation portion bending-deforms in a Z direction, the vibrator vibrates in the Z direction. The elastic modulus of the second elastic deformation portion is higher than the elastic modulus of the first elastic deformation portion. A magnetic core and a coil are provided in the vibrator, and a magnet is provided on the case side. Driving signals of different frequencies are applied to the coil, and the vibrator resonates at a low vibration frequency in the X direction that is a first direction and resonates at a high vibration frequency in the Z direction that is a second direction.

### CLAIM OF PRIORITY

This application claims benefit of Japanese Patent Application No. 2010-281552 filed on Dec. 17, 2010, which is hereby incorporated by reference in its entirety.

### BACKGROUND

1. Field of the Disclosure

The present disclosure relates to a vibration generator that generates vibrations in vibration modes having a plurality of resonant points, and in particular, relates to a vibration generator that can be made small in size with a minimum number of parts.

2. Description of the Related Art

Vibration generators are mounted in portable devices having a telephone function. The vibration generators are driven mainly when there is notification of reception of the telephone function.

In existing mainstream vibration generators, a weight, which is biased, is fixed to a rotary shaft of a small motor, and vibrations are generated by a reaction force of the weight when the rotary shaft of the small motor is rotated. However, in vibration generators using small motors, a rotary force of a roller is converted into vibrations. Thus, the energy conversion efficiency is poor and the power consumption is large.

In recent portable devices, not only is the reception of a telephone function notified through vibrations but also a reaction force for an operation input is transmitted through vibrations when the operation input is performed on a touch pad by a finger touching an operation portion displayed on a display. In this case, when the operation reaction force is transmitted through vibrations of the same vibration frequency as that of the vibrations for notifying the reception, the vibration frequency is too low and thus a sharp operation reaction force cannot be provided.

A vibration generator using a small motor can also output vibrations of a high vibration frequency by increasing an input voltage to increase the number of rotation of a rotary shaft. However, in this case, the power consumption becomes large, and a time required when switching between a low vibration frequency and the high vibration frequency is lengthened.

In a vibration generator disclosed in Japanese Unexamined Patent Application Publication No. 2007-111619, a first vibrator is supported by a first leaf spring, a second vibrator is mounted on the first vibrator via a second leaf spring, and the spring constant of the first leaf spring is higher than that of the second leaf spring. In the vibration generator, the natural vibration frequency of the first vibrator and the natural vibration frequency of the second vibrator are different from each other. Thus, vibrations having two resonant points can be achieved by applying driving signals of different frequencies to a coil wound in the second vibrator.

In the vibration generator disclosed in Japanese Unexamined Patent Application Publication No. 2007-111619, it is not necessary to change an input voltage as in a vibration generator using a small motor, and the vibrators can be vibrated at different resonant points by changing the frequency of an inputted driving signal.

However, the vibration generator disclosed in Japanese Unexamined Patent Application Publication No. 2007-111619 uses the two vibrators having different weights and the two types of leaf springs having different spring constants, and thus has a large number of parts, which requires a large size. In addition, while the vibration generator is driven with the resonant frequency changed, when one vibrator resonates, the other vibrator may become merely a load and thus the vibration energy generated as a whole is likely to be small.

### SUMMARY

A vibration generator includes: a case; a vibrator supported by the case via an elastic support member; and a magnetic driving portion for applying a vibration force to the vibrator. The elastic support member has a first elastic modulus that vibrates the vibrator in a first direction, and a second elastic modulus that vibrates the vibrator in a second direction perpendicular to the first direction, and the second elastic modulus and the first elastic modulus are different from each other. By the magnetic driving portion, the vibrator is driven in the first direction at a first vibration frequency or driven in the second direction at a second vibration frequency different from the first vibration frequency.

### BRIEF DESCRIPTION OF THE DRAWINGS

FIG. 1 is an exploded perspective view of a vibration generator according to a first embodiment of the present invention;

FIG. 2 is a bottom view showing a vibrator and elastic support members of the vibration generator shown in FIG. 1;

FIG. 3 is a cross-sectional view taken along the III-III line in FIG. 2;

FIG. 4 is an enlarged plan view of the elastic support member;

FIGS. 5A and 5B are illustration diagrams showing the arrangement of magnets of a magnetic driving portion;

FIG. 6 is an illustration diagram showing the arrangement of magnets of a magnetic driving portion provided in a vibration generator according to a second embodiment;

FIG. 7 is an illustration diagram showing the arrangement of coils and magnets of a magnetic driving portion provided in a vibration generator according to a third embodiment; and

FIG. 8 is an illustration diagram of a portable device that includes a vibration generator.

### DESCRIPTION OF THE EXEMPLARY EMBODIMENTS

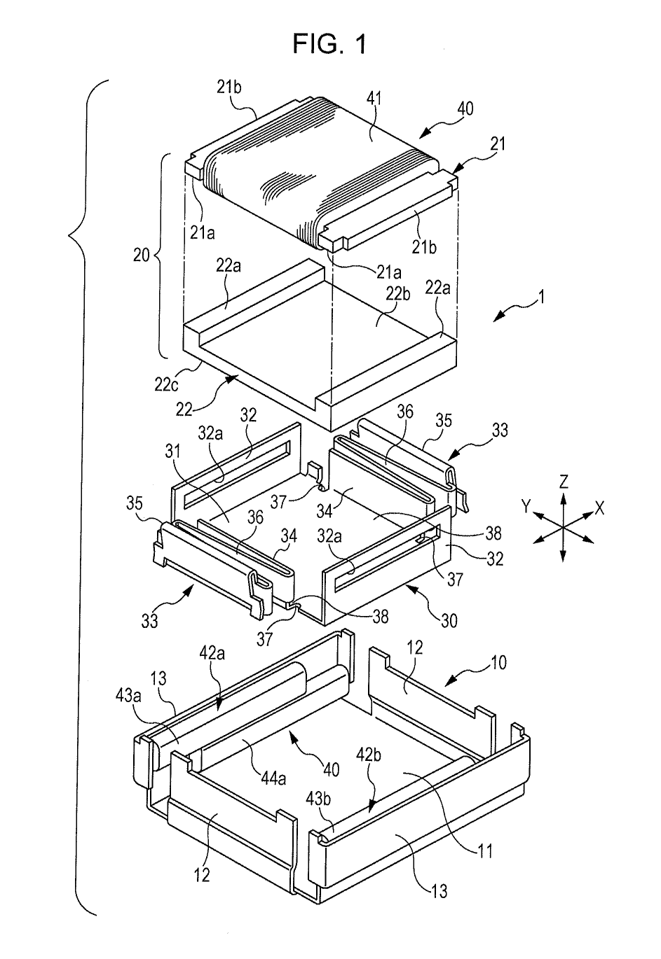

As shown in FIG. 1, a vibration generator 1 according to an embodiment of the present invention includes a case 10, a vibrator 20, a support 30 that supports the vibrator 20, and elastic support members 33 that support the vibrator 20 and the support 30 with respect to the case 10. A magnetic driving portion 40 is provided between the case 10 and the vibrator 20.

In the vibration generator 1, an X direction is a first direction, a Z direction is a second direction, and a Y direction is a third direction.

As shown in FIG. 1, in the case 10, a bottom plate portion 11, a pair of fixed plate portions 12 that are bent perpendicularly from the bottom plate portion 11 to face each other in the X direction, and a pair of magnet support plate portions 13 that are bent perpendicularly from the bottom plate portion 11 to face each other in the Y direction, are integrally formed.

The vibrator 20 includes a magnetic core 21 and a magnetic yoke 22. The magnetic core 21 is formed from a magnetic metal material in a plate shape, and a coil 41 constituting the magnetic driving portion 40 is provided thereon. The coil 41 is formed by a thin copper wire being wound around the magnetic core 21.

The magnetic yoke 22 is formed from the same magnetic metal material as that of the magnetic core 21. The magnetic yoke 22 has a recess 22b at its central portion, and has upward-facing connection surfaces 22a on both sides of the recess 22b in the Y direction. When the magnetic core 21 is stacked on the magnetic yoke 22, the lower half of the coil 41 is accommodated in the recess 22b, and downward-facing connection surfaces 21a of projection portions of the magnetic core 21 that project from the coil 41 are located on and connected to the connection surfaces 22a of the magnetic yoke 22 and fixed thereto by an adhesive or the like.

The support 30 that supports the vibrator 20 is formed by bending a leaf spring material. For example, the case 10 is formed from a plate made of a magnetic material such as an iron material, and the support 30 is formed from a non-magnetic metal plate such as stainless steel. The support 30 includes a support bottom portion 31 and a pair of facing plate portions 32 that are bent perpendicularly from the support bottom portion 31 to face each other in the Y direction. Each of the facing plate portions 32 has an opening 32a elongated in the X direction.

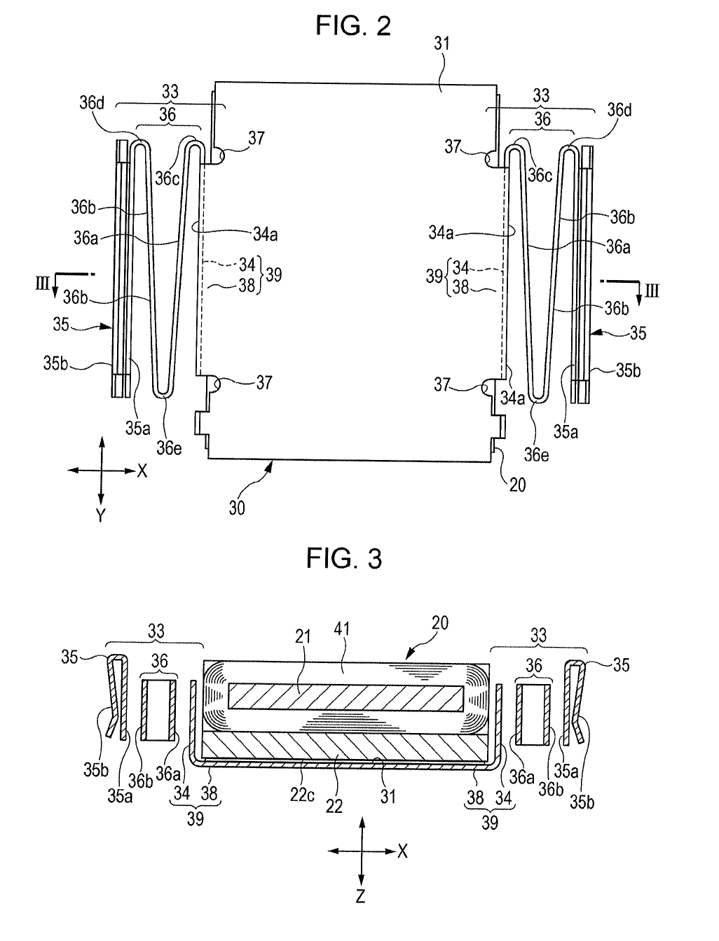

As shown in FIGS. 2 and 3, the vibrator 20 is mounted on the support 30. As shown in FIG. 1, in the magnetic core 21, projection end portions 21b are integrally formed so as to project in the Y direction beyond the connection surfaces 21a. The projection end portions 21b are engaged with the openings 32a of the facing plate portions 32, whereby the vibrator 20 is positioned and fixed to the support 30.

The magnetic core 21 and the support 30 may be fixed to each other only by the structure in which the projection end portions 21b are engaged with the openings 32a, but a lower surface 22c of the magnetic yoke 22 and the support bottom portion 31 of the support 30 may partially be fixed to each other by an adhesive or the like.

The elastic support members 33 are integrally formed on both sides of the support 30 in the X direction so as to be connected to the support bottom portion 31.

As shown in FIGS. 1 and 2, the elastic support member 33 projecting from the support bottom portion 31 in one direction of the X direction and the elastic support member 33 projecting from the support bottom portion 31 in the other direction of the X direction are symmetrical to each other about a Y-Z plane.

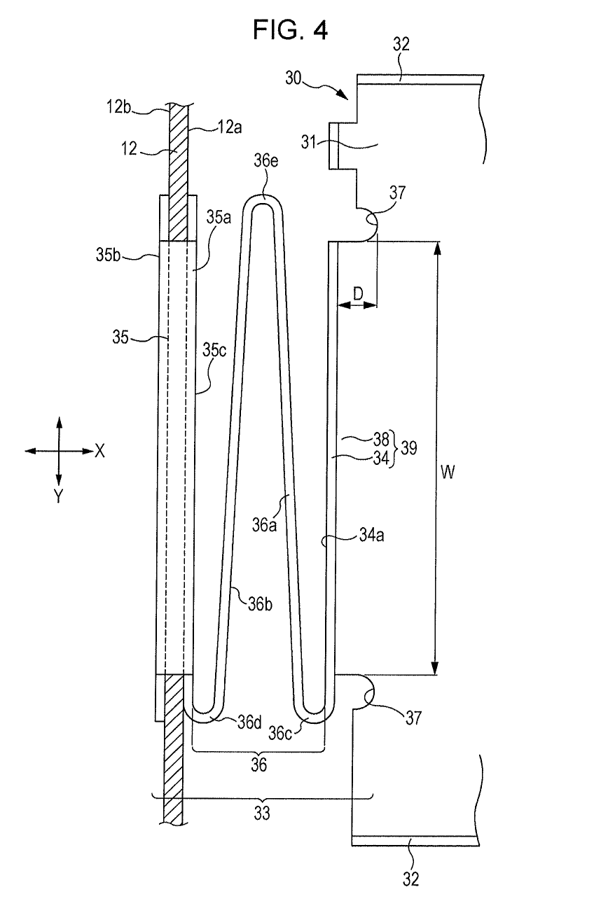

As shown in enlarged view in FIG. 4, each elastic support member 33 includes an intermediate plate portion 34. As shown in FIG. 3, the intermediate plate portion 34 is formed so as to be bent perpendicularly and upwardly in the Z direction from a side portion of the support bottom portion 31 of the support 30 that faces in the X direction. In FIG. 4, the length dimension of the intermediate plate portion 34 in the Y direction is indicated by W.

In the elastic support member 33, a holding portion 35 is provided at a position spaced apart externally in the X direction from the intermediate plate portion 34. As shown in FIG. 3, in the holding portion 35, a holding plate portion 35a parallel to the intermediate plate portion 34, and an elastic holding piece 35b bent so as to face the holding plate portion 35a, are integrally formed. As shown in FIG. 4, the fixed plate portion 12 of the case 10 is sandwiched between the holding plate portion 35a and the elastic holding piece 35b. At that time, the holding plate portion 35a closely contacts the inner surface 12a of the fixed plate portion 12, and the elastic holding piece 35b is elastically pressed against the outer surface 12b of the fixed plate portion 12, whereby the holding portion 35 is fixed to the fixed plate portion 12.

As shown in FIG. 4, the outer surface 34a of the intermediate plate portion 34 and the inner surface 35c of the holding plate portion 35a are parallel to each other, and a first elastic deformation portion 36 is provided therebetween. The first elastic deformation portion 36 is integrally formed with the intermediate plate portion 34 and the holding plate portion 35a from the leaf spring material constituting the support 30.

The first elastic deformation portion 36 includes two deformation plate portions 36a and 36b. The deformation plate portions 36a and 36b have band plate shapes in which the length dimension in the Y direction, which is the third direction, is larger than the width dimension in the Z direction. The thickness directions of the deformation plate portions 36a and 36b are directed to the first direction (X direction), the width directions thereof are directed to the Z direction, which it the second direction, and the longitudinal directions thereof are directed to the Y direction, which is the third direction.

A base of the deformation plate portion 36a is connected to the intermediate plate portion 34 via a base bent portion 36c, and a base of the deformation plate portion 36b is connected to the holding plate portion 35a via a base bent portion 36d. An end of the deformation plate portion 36a and an end of the deformation plate portion 36b are connected to each other via an intermediate bent portion 36e.

In the deformation plate portions 36a and 36b, the longitudinal directions thereof are directed to the Y direction and the thickness directions thereof are directed to the X direction. Thus, a bending strain occurs therein mainly in the X direction, which is the first direction, and its direction of curvature is the Y direction. The bending center lines of the base bent portion 36c, the base bent portion 36d, and the intermediate bent portion 36e extend in the Z direction, which is the second direction, and a bending strain occurs therein mainly in the X direction, which is the first direction.

The first elastic deformation portion 36 elastically deforms in the X direction, which is the first direction, with a first elastic modulus due to the bending strains of the deformation plate portions 36a and 36d and the bending strains of the base bent portions 36c and 36d and the intermediate bent portion 36e. The bending stress required to provide a bending strain in the first direction to the first elastic deformation portion 36 is small, and the first elastic modulus is a relatively small value. The vibrator 20 and the support 30 on which the vibrator 20 is mounted can vibrate in the X direction due to a strain of the first elastic deformation portion 36 in the X direction. A first natural vibration frequency at that time is determined by the total weight of the vibrator 20 and the support 30 and the first elastic modulus. Since the first elastic modulus is a relatively small value, the first natural vibration frequency is relatively low.

When the vibrator 20 vibrates in the X direction which is the first direction, the vibration direction is the shear direction of a deformation plate portion 38 that constitutes a second elastic deformation portion 39. Further, the second elastic deformation portion 39 has a sufficiently high flexural rigidity as compared to that of the first elastic deformation portion 36. Thus, when the vibrator 20 and the support 30 vibrate in the Z direction which is the first direction, the second elastic deformation portion 39 hardly deforms.

When the vibrator 20 and the support 30 move in the Z direction which is the second direction, a shear force in the width direction (Z direction) is applied to the deformation plate portions 36a and 36b and the bent portions 36c, 36d, and 36e, which constitute the first elastic deformation portion 36, and a slight twisting force is applied thereto. The force required to deform the first elastic deformation portion 36 in the shear direction and the twisting direction is sufficiently great as compared to the force required to bending-deform the first elastic deformation portion 36 in the X direction. In other words, the elastic modulus of the first elastic deformation portion 36 in the Z direction is a very high value as compared to the first elastic modulus in the X direction. Thus, when the vibrator 20 and the support 30 move in the Z direction which is the second direction, an elastic strain is unlikely to occur in the first elastic deformation portion 36, and when the vibrator 20 and the support 30 vibrate in the Z direction, the first elastic deformation portion 36 is unlikely to generate vibration noise in an unwanted direction.

As shown in FIG. 4, in the elastic support member 33, on both ends of the intermediate plate portion 34, notches 37 are formed so as to cut into the support bottom portion 31 of the support 30 in the X direction. In FIG. 4, the cut depth dimensions of the notches 37 are indicated by D. A portion, of the leaf spring material constituting the support bottom portion 31, in the range sandwiched between the notches 37, namely, a portion of the leaf spring material that has the width dimension W and the cut depth dimension D, is the deformation plate portion 38. The deformation plate portion 38 is not fixed to the lower surface 22c of the magnetic yoke 22 constituting the vibrator 20, by an adhesive or the like. The deformation plate portion 38 and the intermediate plate portion 34 bent from the deformation plate portion 38 constitute the second elastic deformation portion 39.

When the vibrator 20 and the support 30 move in the Z direction which is the second direction, the second elastic deformation portion 39 elastically deforms. The main deforming portion of the second elastic deformation portion 39 is the deformation plate portion 38, and the deformation plate portion 38 generates a bending strain in the Z direction in response to the movement of the vibrator 20 and the support 30 in the Z direction. At that time, a bending strain also occurs at the bending boundary between the intermediate plate portion 34 and the deformation plate portion 38.

The deformation plate portion 38 is long in the Y direction that is the width direction, and has a short dimension in the X direction that is the direction of curvature when the deformation plate portion 38 is bent. Thus, a second elastic modulus when the vibrator 20 and the support 30 move in the Z direction, which is the second direction, and the second elastic deformation portion 39 bends is a very high value as compared to the first elastic modulus of the first elastic deformation portion 36 in the X direction. A second natural vibration frequency when the vibrator 20 and the support 30 vibrate in the Z direction is determined by the weights of the vibrator 20 and the support 30 and the second elastic modulus. The second natural vibration frequency is very high as compared to the first natural vibration frequency when the vibrator 20 and the support 30 vibrate in the X direction.

When the cut depths D of the notches 37 are changed, the length dimension of the deformation plate portion 38 in the X direction changes and the second elastic modulus changes. Thus, the natural vibration frequency of the vibrator 20 and the support 30 in the Z direction, which is the second direction, can be adjusted by changing the cut depths D. It should be noted that change of the cut depths D of the notches 37 does not provide any change to the first elastic deformation portion 36, and thus the first elastic modulus of the first elastic deformation portion 36 does not change when the second elastic modulus is adjusted.

As shown in FIG. 1, the case 10 is provided with the paired magnet support plate portions 13 that face each other in the Y direction. A magnetic field generation member 42a that, together with the coil 41, constitutes the magnetic driving portion 40 is fixed to the inner surface of one of the magnet support plate portions 13, and a magnetic field generation member 42b that, together with the coil 41, constitutes the magnetic driving portion 40 is fixed to the inner surface of the other magnet support plate portion 13.

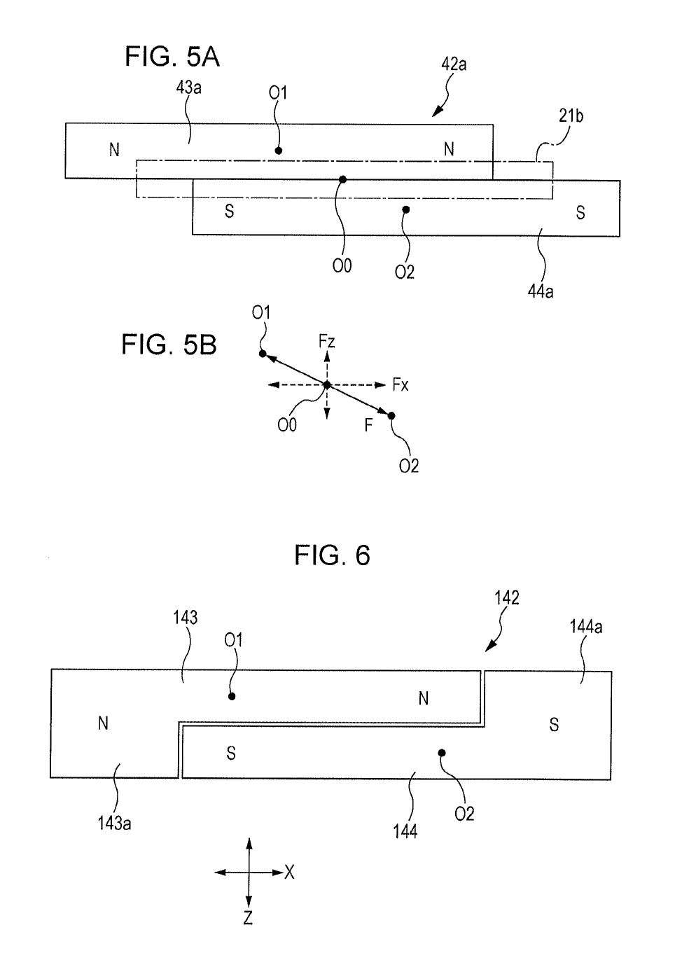

As shown in FIG. 5A, the magnetic field generation member 42a includes an upper magnet 43a located on the upper side and a lower magnet 44a located on the bottom plate portion 11 side. Both the upper magnet 43a and the lower magnet 44a have elongated shapes in which the length dimension in the X direction is larger than the width dimension in the Z direction. The center O1 of the upper magnet 43a is located on the left side in FIG. 5A, and the center O2 of the lower magnet 44a is located on the right side in FIG. 5A. The surface of the upper magnet 43a that faces the projection end portion 21b of the magnetic core 21 is polarized to N pole, and the surface of the lower magnet 44a that faces the projection end portion 21b is polarized to S pole.

When no external force is applied to the vibrator 20 and the vibrator 20 is supported by the elastic support members 33 in a neutral position, the center O0 of the projection end portion 21b of the magnetic core 21 is located at the midpoint between the center O1 and the center O2 in the X direction and also located at the midpoint therebetween in the Z direction.

The magnetic field generation member 42b that faces the magnetic field generation member 42a shown in FIG. 5 is symmetrical to the magnetic field generation member 42a about an X-Z plane. The magnetic field generation member 42b includes an upper magnet 43b that is plane-symmetrical to the upper magnet 43a, and a lower magnet 44b that is plane-symmetrical to the lower magnet 44a. It should be noted that the lower magnet 44b does not appear in FIG. 1. The surface of the upper magnet 43b of the magnetic field generation member 42b that faces the projection end portion 21b of the magnetic core 21 is polarized to S pole, and the surface of the lower magnet 44b that faces the projection end portion 21b is polarized to N pole. In other words, the surfaces of the upper magnet 43a and the upper magnet 43b that face the projection end portion 21b have opposite magnetic poles, and the surfaces of the lower magnet 44a and the lower magnet 44b that face the projection end portion 21b have opposite magnetic poles.

FIG. 8 illustrates one example of a portable device 50 that includes the vibration generator 1.

The portable device 50 has a telephone function and an e-mail sending/receiving function, and the vibration generator 1 is installed inside a case 51. In addition, a driving circuit 52 for driving the vibration generator 1 is included in the case 51.

The vibration generator 1 has two resonant modes. A first resonant mode is vibrations at the first natural vibration frequency when the vibrator 20 and the support 30 vibrate in the X direction, which is the first direction. A second resonant mode is vibrations at the second natural vibration frequency when the vibrator 20 and the support 30 vibrate in the Z direction, which is the second direction. As described above, the second natural vibration frequency is sufficiently higher than the first natural vibration frequency.

When the vibration generator 1 is driven in the first resonant mode, a driving signal having a first frequency that agrees with the first natural vibration frequency or having a frequency close to the first frequency is applied from the driving circuit 52 to the coil 41. As the driving signal, a rectangular-wave-shaped pulse current may intermittently be applied to the coil 41, or an alternate current may be applied to the coil 41. At that time, the frequency at which the magnetic pole of the surface of each projection end portion 21b of the magnetic core 21 changes to N pole or S pole agrees with the first natural vibration frequency or is a value close to the first natural vibration frequency.

When the coil 41 is energized and each projection end portion 21b of the magnetic core 21 serves as a magnetic pole, a driving force F is applied to the center O0 of the projection end portion 21b in the direction of a straight line along which the centers O1, O0, and O2 are aligned, as shown in FIG. 5B. When the driving signal has the first frequency or the frequency close to the first frequency, the vibrator 20 and the support 30 resonates in the X direction in the first resonant mode due to a force component Fx of the driving force F in the X direction.

When the vibration generator 1 is driven in the second resonant mode, a driving signal having a second frequency that agrees with the second natural vibration frequency or having a frequency close to the second frequency is applied from the driving circuit 52 to the coil 41. At that time, the vibrator 20 and the support 30 resonate in the Z direction in the second resonant mode due to a force component Fz of the driving force F in the Z direction.

For example, if the first frequency is set to about 150 to 200 Hz, when the telephone function or the e-mail sending/receiving function of the portable device 50 is in a receiving state, vibrations suitable for notifying the owner of the state are generated.

If the second frequency is set to about 400 to 600 Hz, vibrations suitable as vibrations for an operation reaction force applied to a finger when an operation section is operated with the finger are generated.

For example, in the portable device 50 shown in FIG. 8, a display screen 53 is provided to the case 51, and an image is displayed on a color liquid crystal display panel or the like. A touch pad that enables a coordinate input, such as an electrostatic capacitance type or a resistance type, is provided on the display screen 53. When images of a plurality of operation buttons 54 are displayed on the display screen 53, if a finger touches any one of the operation buttons 54, the touch pad enters a detection state, and it is recognized which of the operation buttons 54 is operated, by a control circuit included in the case 51. At that time, when an instruction is issued from the control circuit to the driving circuit 52 and a driving signal of the second frequency is applied to the coil 41 for a short period of time, the case 51 vibrates at a high frequency for a short period of time to apply a sharp operation reaction force to the finger touching the operation button 54.

In the driving circuit 52, it is not necessary to change a driving voltage, and only by changing the frequency of the driving signal, the case 51 can be vibrated at a relatively low vibration frequency to notify a receiving state, or the case 51 can be vibrated at a high vibration frequency for a short period of time to cause a finger to feel a sharp operation reaction force.

Which frequency is appropriate for causing a finger to feel an operation reaction force when the vibration generator 1 is vibrated with a second driving signal, depends on the size of each case 51 and a vibration transmission structure.

Thus, as shown in FIG. 4, by changing the cut depths D of the notches 37 formed in the support bottom portion 31 of the support 30 to change the second elastic modulus of the second elastic deformation portion 39, vibrations of an appropriate vibration frequency can be generated in each portable device to apply an appropriate operation reaction force. In this case, even when the cut depths D of the notches 37 are changed, the change does not influence the first elastic modulus of the first elastic deformation portion 36, and thus the vibration mode for notifying reception does not change.

Further, the first resonant mode and the second resonant mode are not limited to the receiving mode and the operation button 54 operation reaction force mode. When another operation is performed, the case 51 can be vibrated in the first resonant mode or the second resonant mode. For example, when a game image is displayed on the display screen 53 and a game operation is performed, the case 51 can be vibrated by switching between or combining the first resonant mode and the second resonant mode in accordance with change of the display content of the display screen 53.

FIG. 6 illustrates a magnetic field generation member 142 provided in a vibration generator according to a second embodiment.

In the magnetic field generation member 142, at a left end portion of an upper magnet 143, an extension portion 143a is integrally formed so as to extend to a position that overlaps with a lower magnet 144, and at a right end portion of the lower magnet 144, an extension portion 144a is integrally formed so as to extend to a position that overlaps with the upper magnet 143. It should be noted that the extension portion 143a may be formed independently of the main body of the upper magnet 143, and the extension portion 144a may be formed independently of the main body of the lower magnet 144.

In the magnetic field generation member 142 shown in FIG. 6, the extension portions 143a and 144a are provided on both sides in the X direction. Thus, the distance in the X direction between the center (center of gravity) O1 of the upper magnet 143 and the center (center of gravity) O2 of the lower magnet 144 can be lengthened. Thus, the force component Fx of the driving force in the X direction shown in FIG. 5B can be increased, and it is easy to reduce unwanted vibration noise in a direction other than the X direction when the vibrator 20 and the support 30 are driven in the first resonant mode in the X direction.

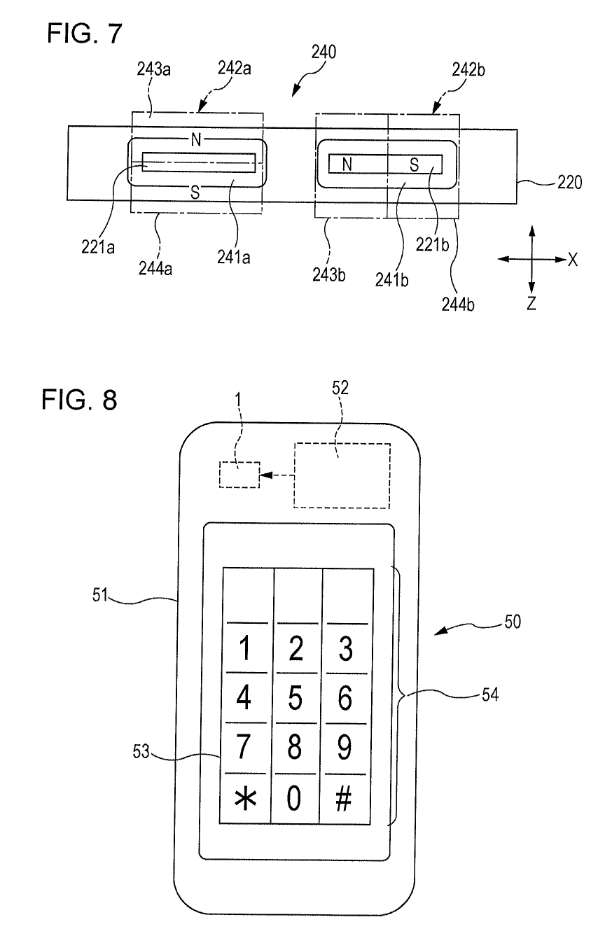

FIG. 7 illustrates a magnetic driving portion 240 mounted in a vibration generator according to a third embodiment of the present invention.

In this embodiment, the vibrator 220 is provided with two magnetic cores 221a and 221b, a coil 241a is wound around the magnetic core 221a, and a coil 241b is wound around the magnetic core 221b.

Two pairs of magnetic field generation members 242a and 242b are fixed to the magnet support plate portions 13 of the case 10. The magnetic field generation member 242a includes an upper magnet 243a and a lower magnet 244a provided separately in the Z direction and the surfaces thereof that face the vibrator 220 have opposite magnetic poles. The magnetic field generation member 242b includes a left magnet 243b and a right magnet 244b provided separately in the X direction, the surfaces thereof that face the vibrator 220 have opposite magnetic poles.

In the vibration generator shown in FIG. 7, when a driving signal of the first frequency is applied to the coil 241b, the vibrator 220 is vibrated at the first natural vibration frequency in the X direction, which is the first direction, by the left magnet 234b, the right magnet 244b, and the magnetic field generated at that time. When a driving signal of the second frequency is applied to the coil 241a, the vibrator 220 is vibrated at the second natural vibration frequency in the Z direction, which is the second direction, by the upper magnet 243a, the lower magnet 244a, and the magnetic field generated at that time.

What is claimed is:

1. A vibration generator comprising:
a case;
a vibrator supported by the case via an elastic support member; and
a magnetic driving portion that applies a vibration force to the vibrator, wherein
the elastic support member has a first elastic modulus that vibrates the vibrator in a first direction, and a second elastic modulus that vibrates the vibrator in a second direction perpendicular to the first direction, and the second elastic modulus and the first elastic modulus are different from each other, and
by the magnetic driving portion, the vibrator is driven in the first direction at a first vibration frequency or driven in the second direction at a second vibration frequency different from the first vibration frequency.

2. The vibration generator according to claim 1, wherein the elastic support member includes a first elastic deformation portion that generates a bending strain with the first elastic modulus, and a second elastic deformation portion that generates a bending strain with the second elastic modulus.

3. The vibration generator according to claim 2, wherein
the first elastic deformation portion comprises a leaf spring portion of which a thickness direction is directed to the first direction and which extends in a third direction perpendicular to both the first direction and the second direction,
the second elastic deformation portion comprises a leaf spring portion of which a thickness direction is directed to the first direction and which extends in the first direction, and
a bending direction of the second elastic deformation portion is a shear direction of the first elastic deformation portion.

4. The vibration generator according to claim 3, wherein a notch for setting a length of the second elastic deformation portion in the first direction is provided in the elastic support member.

5. The vibration generator according to claim 1, wherein
the second elastic modulus is higher than the first elastic modulus, and
the second vibration frequency is higher than the first vibration frequency.

6. The vibration generator according to claim 1, wherein a driving circuit that switches and applies a driving signal of a first frequency to drive the vibrator at the first vibration frequency or a driving signal of a second frequency to drive the vibrator at the second vibration frequency, is provided to a coil provided to the magnetic driving portion.

7. The vibration generator according to claim 6, wherein
the vibration generator is mounted in a portable device having a telephone function,
when there is reception of the telephone function, the driving signal of the first frequency is applied to the coil, and
when an operation section provided in the portable device is operated, the driving signal of the second frequency is applied to the coil.
